(19) United States
(12) Patent Application Publication
(10) Pub. No.: US 2024/0202037 A1
(43) Pub. Date: Jun. 20, 2024

(54) Managing Physical Resource Usage Via an On-Demand Virtual Queue

(71) Applicant: International Business Machines Corporation, Armonk, NY (US)

(72) Inventors: Paul Llamas Virgen, Guadalajara (MX); Priyansh Jaiswal, Boca Raton, FL (US); Peeyush Jaiswal, Boca Raton, FL (US)

(21) Appl. No.: 18/067,439

(22) Filed: Dec. 16, 2022

(51) Int. Cl. G06F 9/50

(52) U.S. Cl. CPC G06F 9/5038; G06F 9/505

(57) ABSTRACT

Managing high-demand physical resource usage is provided. An identification of a first physical resource to track availability of the first physical resource via an on-demand virtual queue is received from a first user. An image of the first physical resource is uploaded to the on-demand virtual queue. The image containing metadata regarding a geographic location of the first physical resource. A request to utilize the first physical resource is received from a second user. The second user is added to the on-demand virtual queue for the first physical resource. An indication that the first physical resource is available with the geographic location of the first physical resource is sent to the second user who is first in the on-demand virtual queue. The second user is removed from the on-demand virtual queue in response to receiving an indication that the second user finished utilizing the first physical resource.

### BACKGROUND

### 1. Field

The disclosure relates generally to physical resource scheduling and more specifically to managing physical resource usage via an on-demand virtual queue.

### 2. Description of the Related Art

Physical resource scheduling requires consideration of the dynamic, time-varying, and unpredictable nature of an environment, such as, for example, a manufacturing environment. Scheduling ensures all physical resources are being assigned in a certain sequence and with related usage durations. Scheduling includes the allocation of physical resources to users in order to ensure completion of activities, tasks, jobs, or projects in a desired amount of time.

### SUMMARY

According to one illustrative embodiment, a computer-implemented method for managing high-demand physical resource usage is provided. A computer receives an identification of a first physical resource to track availability of the first physical resource via an on-demand virtual queue from a first user who wants to utilize the first physical resource. The computer uploads an image of the first physical resource to the on-demand virtual queue. The image containing metadata regarding a geographic location of the first physical resource. The computer receives a request to utilize the first physical resource from a second user. The computer adds the second user to the on-demand virtual queue for the first physical resource. The computer sends an indication that the first physical resource is available with the geographic location of the first physical resource to the second user who is first in the on-demand virtual queue. The computer removes the second user from the on-demand virtual queue in response to receiving an indication that the second user finished utilizing the first physical resource. According to other illustrative embodiments, a computer system and computer program product for managing high-demand physical resource usage are provided.

### BRIEF DESCRIPTION OF THE DRAWINGS

FIG. 1 is a pictorial representation of a computing environment in which illustrative embodiments may be implemented;

FIG. 2 is a diagram illustrating an example of a physical resource management process in accordance with an illustrative embodiment;

FIGS. 3A-3B are a flowchart illustrating a process for physical resource management in accordance with an illustrative embodiment; and

FIG. 4 is a flowchart illustrating a process for managing on-demand virtual queues for high-demand physical resources in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

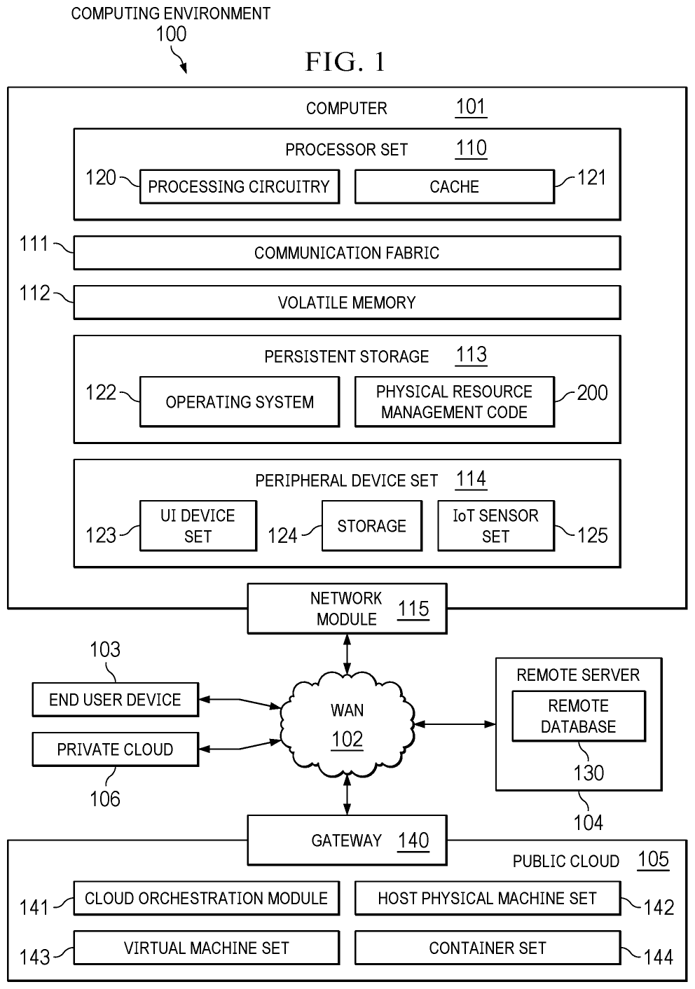

With reference now to the figures, and in particular, with reference to FIG. 1, a diagram of a data processing environment is provided in which illustrative embodiments may be implemented. It should be appreciated that FIG. 1 is only meant as an example and is not intended to assert or imply any limitation with regard to the environments in which different embodiments may be implemented. Many modifications to the depicted environment may be made.

FIG. 1 shows a pictorial representation of a computing environment in which illustrative embodiments may be implemented. Computing environment 100 contains an example of an environment for the execution of at least some of the computer code involved in performing the inventive methods, such as physical resource management code 200. For example, physical resource management code 200 enables an on-demand virtual queuing schema for use cases where management of high-demand physical resource usage is needed. Physical resource management code 200 also generates insights related to substitution of a currently requested physical resource with an equivalent physical resource having same or similar characteristics, qualities, features, attributes, capabilities, or the like to optimize usage of physical resources in any type of environment, such as, for example, a manufacturing environment, production environment, healthcare environment, laboratory environment, maintenance environment, business environment, or the like. For example, physical resource management code 200 can identify and propose changes to current physical resource usage by a user by proposing an equivalent physical resource that decreases the user's wait time in a virtual queue and increases resource utilization. Physical resource management code 200 can utilize one or more physical resource identification techniques, such as, for example, computer vision, quick response codes, barcodes, and the like, to identify different physical resources in an environment.

In addition to physical resource management code block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and physical resource management code 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in physical resource management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The physical resource management code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as goggles and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (for example, a customer of an entity that operates computer 101), and may take any of the forms discussed above in connection with computer 101. EUD 103 typically receives helpful and useful data from the operations of computer 101. For example, in a hypothetical case where computer 101 is designed to provide a physical resource management recommendation to an end user, this physical resource management recommendation would typically be communicated from network module 115 of computer 101 through WAN 102 to EUD 103. In this way, EUD 103 can display, or otherwise present, the physical resource management recommendation to the end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a physical resource management recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

Illustrative embodiments generate and manage an on-demand virtual queue for high-demand physical resources. High-demand physical resources can include, for example: physical handheld tools such as screwdrivers, hammers, wrenches, saws, drills, and the like; physical machines such as desktop computers, laptop computers, tablet computers, forklifts, overhead cranes, drill presses, lathes, vehicles, and the like; physical instruments such as spectrometers, electron microscopes, centrifuges, gas analyzers, and the like; physical parts such as processors, memory devices, storage devices, screws, bolts, and the like; or any other object, item, or asset related to an enterprise, company, business, facility, institution, manufacturing plant, machine shop, or the like. In other words, the physical resources do not include nonphysical or intangible resources, such as, for example, computer software. The on-demand virtual queue enables a user who wants to use a physical resource to register in the on-demand virtual queue to receive a notification that the physical resource is available for use, allowing the user to avoid long lines, long wait times, and uncertainty of obtaining the physical resource to use, which decreases down time and costs and increases operational performance. It should be noted that illustrative embodiments generate an on-demand virtual queue for each respective physical resource.

Illustrative embodiments generate the on-demand virtual queue to management usage of a physical resource by dynamically associating that particular physical resource, which illustrative embodiments identify utilizing, for example, computer vision, convolutional neural network, or the like, with a particular user who wants to utilize or apply an action to that physical resource. Illustrative embodiments receive an image, such as, for example, a photograph, video, or the like, of the physical resource from one or more imaging devices, such as, for example, a mounted area camera, mobile phone camera, laptop computer camera, tablet computer camera, or the like, located in an area corresponding to the current geographic location of the physical resource. In addition, illustrative embodiments perform concurrent image verification. For example, illustrative embodiments may receive 3 different images of the same physical resource from 3 different imaging devices and verify whether the 3 different images are in fact of the same physical resource. Illustrative embodiments also optimize use of the on-demand virtual queue to increase performance and decrease time restrictions on use of the physical resource. Thus, illustrative embodiments provide an orderliness to users who want to utilize the physical resource by allowing the users to join the on-demand virtual queue for the physical resource. Further, in response to illustrative embodiments determining that an equivalent physical resource is currently available and can be substituted for the requested physical resource, illustrative embodiments can automatically transfer the user to a different on-demand queue corresponding to the equivalent physical resource providing the user with the opportunity to use the equivalent physical resource sooner decreasing the user's task completion time.

As an illustrative example scenario, a plurality of users wants to utilize a particular manufacturing resource in a manufacturing environment. One user who is tired of waiting to use the manufacturing resource takes an image (e.g., photo) of the manufacturing resource using, for example, a mobile phone. The image includes metadata regarding the coordinates of the current location of the manufacturing resource. The user then uploads the image, which includes the resource geographic location coordinates, to the resource management service of illustrative embodiments. In response to receiving the image, illustrative embodiments analyze the image and identify the manufacturing resource captured in the image utilizing, for example, computer vision.

Afterwards, illustrative embodiments determine whether data regarding the manufacturing resource and location are stored in a database. In response to illustrative embodiments determining that data regarding the manufacturing resource and location do not exist in the database, illustrative embodiments add the manufacturing resource and location to the database and generate an on-demand virtual queue for managing usage of that particular manufacturing resource. Illustrative embodiments then place the user requesting use of that particular manufacturing resource in the on-demand virtual queue for that particular manufacturing resource.

Subsequently, another user uploads an image and location of the same manufacturing resource to the resource management service of illustrative embodiments. In response to illustrative embodiments identifying the manufacturing resource in the image, illustrative embodiments determine whether data regarding the manufacturing resource and location are stored in the database. In response to illustrative embodiments determining that data regarding the manufacturing resource and location do exist in the database, illustrative embodiments place that other user in the on-demand virtual queue for that particular manufacturing resource. Similarly, illustrative embodiments will add all other users who upload an image and location of the same manufacturing resource (or 98% similar image and location) to that same on-demand virtual queue for managing usage of that particular manufacturing resource.

When illustrative embodiments determine that a particular user's turn to use the manufacturing resource has arrived according to the on-demand virtual queue, illustrative embodiments alert that particular user by sending a notification to, for example, the user's mobile phone. In response to illustrative embodiments receiving an indication that the user has finished utilizing the manufacturing resource, illustrative embodiments remove that particular user from the on-demand virtual queue.

Illustrative embodiments track when each respective user in the on-demand virtual queue starts and finishes usage of the manufacturing resource. If the manufacturing resource is stationary, then illustrative embodiments determine whether the current location of the user (e.g., coordinates of the user's mobile phone) matches the location of the manufacturing resource (e.g., coordinates metadata contained in the image of the manufacturing resource). When illustrative embodiments determine that the user's current location matches the location of the manufacturing resource, illustrative embodiments determine that the user is utilizing the manufacturing resource. When illustrative embodiments later determine that the user's current location no longer matches the location of the manufacturing resource, illustrative embodiments determine that the user has finished utilizing the manufacturing resource and remove that user from the on-demand virtual queue.

If the manufacturing resource is non-stationary (i.e., can be moved by a user), then illustrative embodiments will match the current user's location against the location of the manufacturing resource. Once the user enters the location of the manufacturing resource and immediately goes to another location indicating that the user has moved the manufacturing resource to a new location, which the user had already specified when illustrative embodiments added the user to the on-demand virtual queue, illustrative embodiments determine that the user has started utilizing the manufacturing resource. Once the user moves back to the original location of the manufacturing resource, which indicates that the user has returned the manufacturing resource to its original location, illustrative embodiments determine that the user has finished utilizing the manufacturing resource and remove that user from the on-demand virtual queue. Moreover, illustrative embodiments enable each respective user in the on-demand virtual queue to view a live update of each respective user's position in the on-demand virtual queue indicating when a particular user's turn to utilize the manufacturing resource will occur.

Illustrative embodiments can further enhance a user's resource usage experience by pro-actively transferring a user from one on-demand virtual queue to another. For example, the user is currently in an on-demand virtual queue corresponding to a specific physical resource. However, illustrative embodiments determine that when the user's turn to utilize that specific physical resource comes up in accordance with the on-demand virtual queue, the user will need to move a significant distance to obtain that specific physical resource. Illustrative embodiments also determine that another physical resource, which is basically the same type of physical resource as the physical resource the user is already in the on-demand queue for, will be available sooner and is located at a much shorter distance from the user (i.e., in closer proximity). In this example, illustrative embodiments will automatically transfer the user from the current on-demand virtual queue to another on-demand virtual queue corresponding to the equivalent physical resource, which will be available sooner and is at a location closer to the user, and notifies the user of this change in on-demand virtual queues.

As another example, a user is currently in an on-demand virtual queue corresponding to a particular physical resource. However, illustrative embodiments determine that there is another on-demand virtual queue corresponding to another physical resource that is an equivalent physical resource to the particular physical resource the user is already in the on-demand virtual queue for. Illustrative embodiments also determine that this other on-demand virtual queue is shorter (i.e., has fewer users in the queue) than the on-demand virtual queue the user is already registered with. In this example, illustrative embodiments automatically transfer the user from the user's current on-demand virtual queue to the smaller on-demand virtual queue corresponding to the equivalent physical resource and notifies the user of this change in on-demand virtual queues.

Thus, illustrative embodiments provide one or more technical solutions that overcome a technical problem with high-demand physical resource usage by a plurality of users in an environment. As a result, these one or more technical solutions provide a technical effect and practical application in the field of physical resource management.

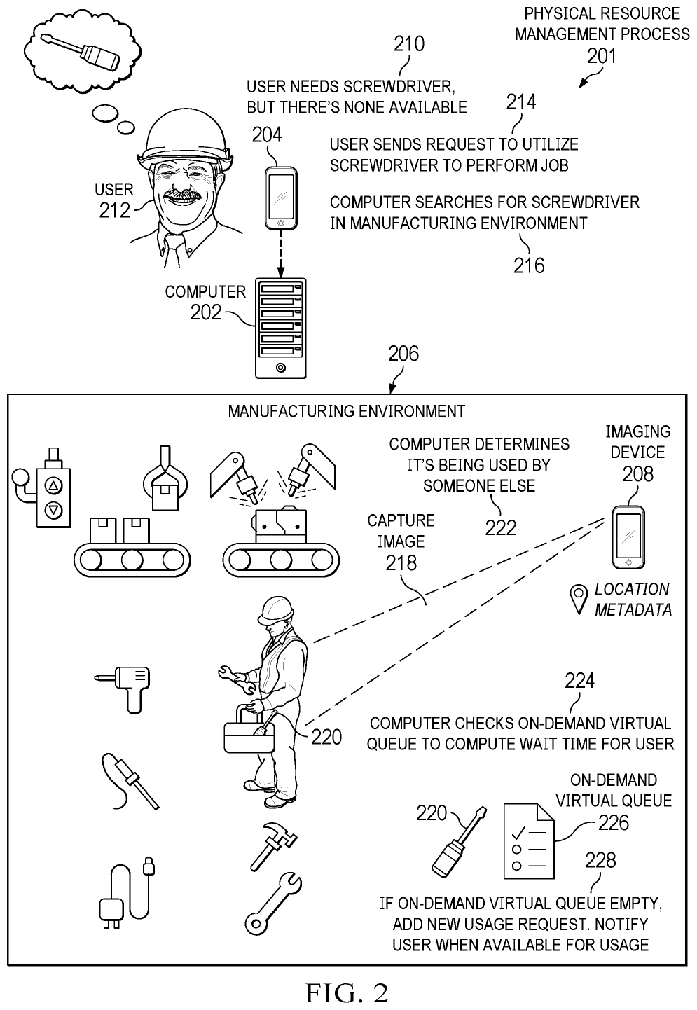

With reference now to FIG. 2, a diagram illustrating an example of a physical resource management process is depicted in accordance with an illustrative embodiment. Physical resource management process 201 may be implemented in a computing environment, such as computing environment 100 in FIG. 1. Physical resource management process 201 utilizes hardware and software components to manage usage of high-demand physical resources by a plurality of users.

In this example, physical resource management process 201 utilizes computer 202, client device 204, manufacturing environment 206, and imaging device 208. However, it should be noted that physical resource management process 201 is intended as an example only and not as a limitation on illustrative embodiments. For example, physical resource management process 201 can utilize any number of computers, client devices, manufacturing environments, imaging devices, and other devices and components not shown. Further, physical resource management process 201 is not limited to a manufacturing environment, but may be utilized in any type of environment where management of physical resource usage by a plurality of users is needed.

In this example, at 210, user 212 needs a screwdriver to perform a job, but none are available. The job may be any type of job needing a screwdriver to perform. At 214, user 212 utilizes client device 204 to send a request to computer 202 to utilize a screwdriver to perform the job in manufacturing environment 206. Computer 202 and client device 204 may be, for example, computer 101 and EUD 103 in FIG. 1.

At 216, computer 202 searches for a screwdriver in manufacturing environment 206 utilizing imaging device 208. Imaging device 208 can represent, for example, a set of imaging devices, such as a set of mounted area cameras, located in manufacturing environment 206. At 218, imaging device 208 captures an image, which contains location metadata, of screwdriver 220 in manufacturing environment 206 and transmits the image of screwdriver 220 to computer 202. Computer 202 utilizes, for example, computer vision to identify screwdriver 220.

At 222, computer 202 determines that screwdriver 220 is being used by another user. At 224, computer 202 checks on-demand virtual queue 226, which corresponds to screwdriver 220, to compute the wait time for user 212 to obtain screwdriver 220. At 228, if computer 202 determines that on-demand virtual queue 226 is empty, then computer 202 adds a new usage request to on-demand virtual queue 226 by adding user 212 to the top of on-demand virtual queue 226. Subsequently, computer 202 notifies user 212 when screwdriver 220 is available for usage.

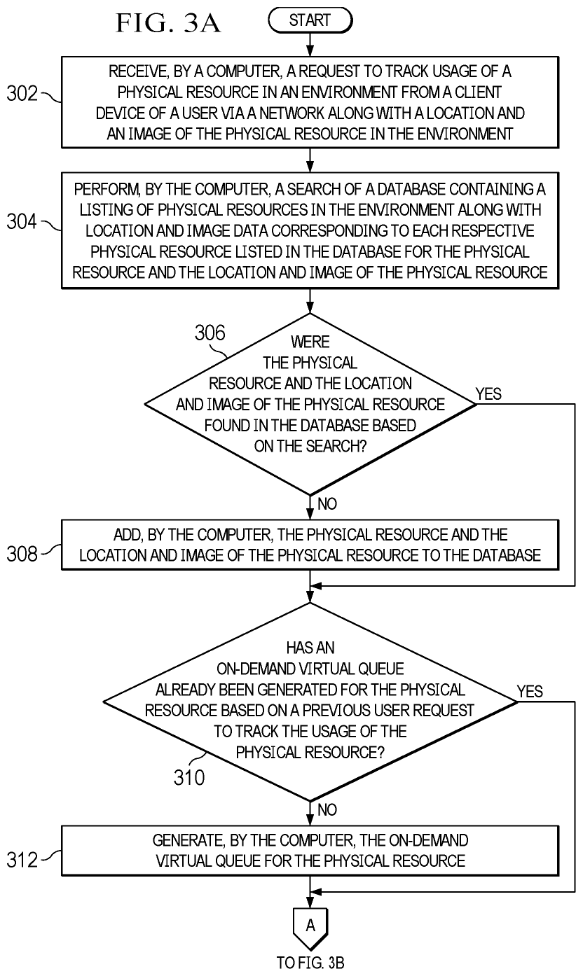

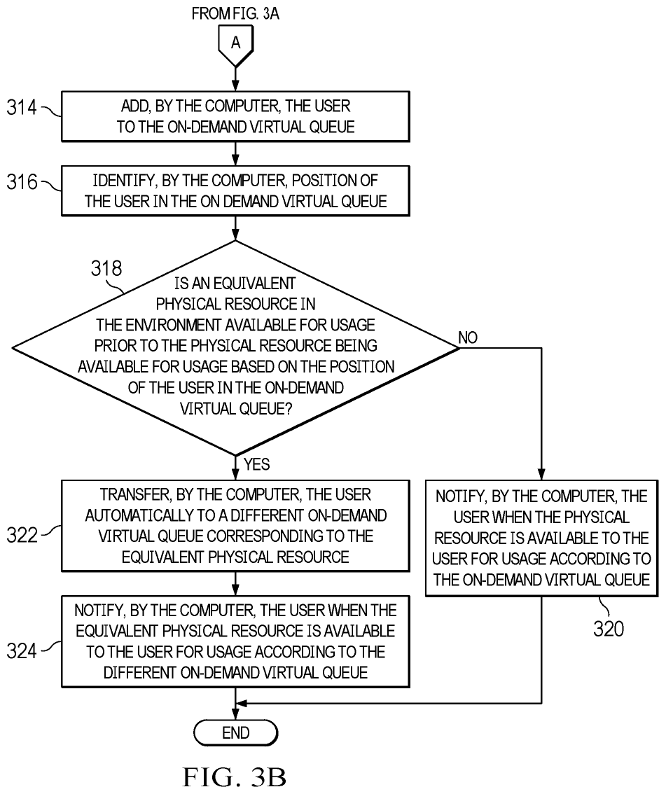

With reference now to FIGS. 3A-3B, a flowchart illustrating a process for physical resource management is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented in physical resource management code 200 in FIG. 1.

The process begins when the computer receives a request to track usage of a physical resource in an environment from a client device of a user via a network along with a location and an image of the physical resource in the environment (step 302). In response to receiving the request, the computer performs a search of a database containing a listing of physical resources in the environment along with location and image data corresponding to each respective physical resource listed in the database for the physical resource and the location and image of the physical resource (step 304).

The computer makes a determination as to whether the physical resource and the location and image of the physical resource were found in the database based on the search (step 306). If the computer determines that the physical resource and the location and image of the physical resource were not found in the database based on the search, no output of step 306, then the computer adds the physical resource and the location and image of the physical resource to the database (step 308). Thereafter, the process proceeds to step 310.

Returning again to step 306, if the computer determines that the physical resource and the location and image of the physical resource were found in the database based on the search, yes output of step 306, then the computer makes a determination as to whether an on-demand virtual queue has already been generated for the physical resource based on a previous user request to track the usage of the physical resource (step 310). If the computer determines that an on-demand virtual queue has not already been generated for the physical resource, no output of step 310, then the computer generates the on-demand virtual queue for the physical resource (step 312). Thereafter, the process proceeds to step 314.

Returning again to step 310, if the computer determines that the on-demand virtual queue has already been generated for the physical resource based on a previous user request to track the usage of the physical resource, yes output of step 310, then the computer adds the user to the on-demand virtual queue (step 314). In addition, the computer identifies a position of the user in the on-demand virtual queue (step 316).

Afterward, the computer makes a determination as to whether an equivalent physical resource in the environment is available for usage prior to the physical resource being available for usage by the user based on the position of the user in the on-demand virtual queue (step 318). If the computer determines that an equivalent physical resource in the environment is not available for usage prior to the physical resource being available for usage by the user based on the position of the user in the on-demand virtual queue, no output of step 318, then the computer notifies the user when the physical resource is available to the user for usage according to the on-demand virtual queue (step 320). Thereafter, the process terminates.

Returning again to step 318, if the computer determines that an equivalent physical resource in the environment is available for usage prior to the physical resource being available for usage by the user based on the position of the user in the on-demand virtual queue, yes output of step 318, then the computer automatically transfers the user to a different on-demand virtual queue corresponding to the equivalent physical resource (step 322). Furthermore, the computer notifies the user when the equivalent physical resource is available to the user for usage according to the different on-demand virtual queue (step 324). Thereafter, the process terminates.

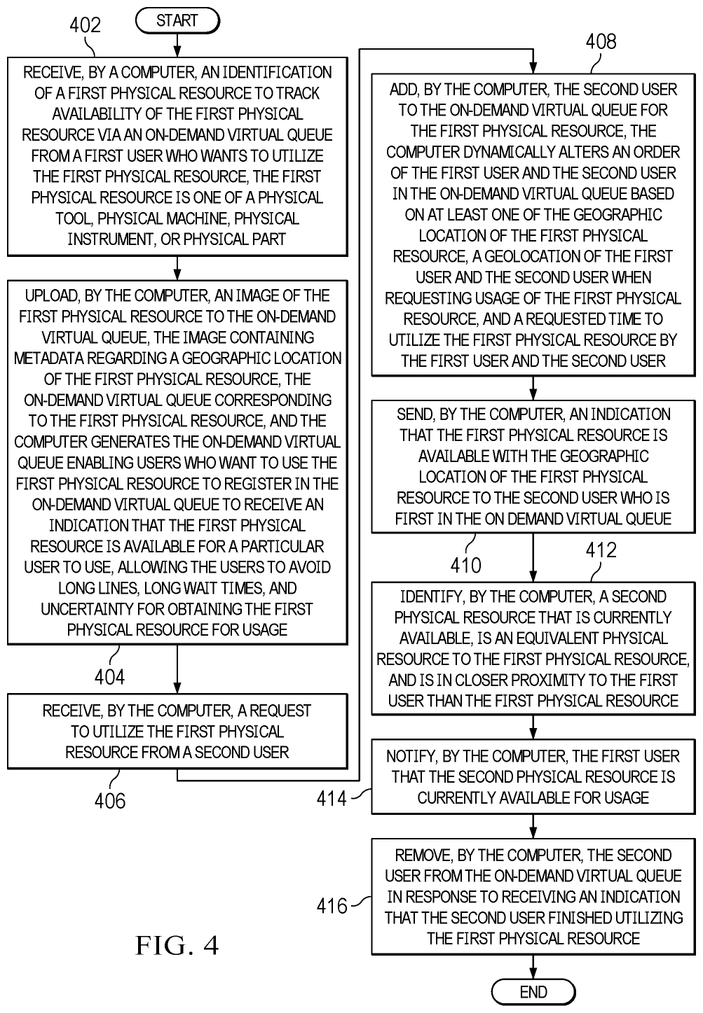

With reference now to FIG. 4, a flowchart illustrating a process for managing on-demand virtual queues for high-demand physical resources is shown in accordance with an illustrative embodiment. The process shown in FIG. 4 may be implemented in a computer, such as, for example, computer 101 in FIG. 1 or computer 202 in FIG. 2. For example, the process shown in FIG. 4 may be implemented in physical resource management code 200 in FIG. 1.

The process begins when the computer receives an identification of a first physical resource to track availability of the first physical resource via an on-demand virtual queue from a first user who wants to utilize the first physical resource (step 402). The first physical resource is one of a physical tool, physical machine, physical instrument, or physical part of an object that is being one of manufactured or repaired. The computer uploads an image of the first physical resource to the on-demand virtual queue (step 404). The image containing metadata regarding a geographic location of the first physical resource. The on-demand virtual queue corresponds to the first physical resource. The computer generates the on-demand virtual queue enabling users who want to use the first physical resource to register in the on-demand virtual queue to receive an indication that the first physical resource is available for a particular user to use, allowing the users to avoid long lines, long wait times, and uncertainty for obtaining the first physical resource for usage.

The computer receives a request to utilize the first physical resource from a second user (step 406). The computer adds the second user to the on-demand virtual queue for the first physical resource (step 408). The computer dynamically alters an order of the first user and the second user in the on-demand virtual queue based on at least one of the geographic location of the first physical resource, a geolocation of the first user and the second user when requesting usage of the first physical resource, and a requested time to utilize the first physical resource by the first user and the second user.

The computer sends an indication that the first physical resource is available with the geographic location of the first physical resource to the second user who is first in the on-demand virtual queue (step 410). Further, the computer identifies a second physical resource that is currently available, is an equivalent physical resource to the first physical resource, and is in closer proximity to the first user than the first physical resource (step 412). Furthermore, the computer notifies the first user that the second physical resource is currently available for usage (step 414). Moreover, the computer removes the second user from the on-demand virtual queue in response to receiving an indication that the second user finished utilizing the first physical resource (step 416). Thereafter, the process terminates.

Thus, illustrative embodiments of the present invention provide a computer-implemented method, computer system, and computer program product for managing physical resource usage via on-demand virtual queues. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing high-demand physical resource usage, the computer-implemented method comprising:
receiving, by a computer, an identification of a first physical resource to track availability of the first physical resource via an on-demand virtual queue from a first user who wants to utilize the first physical resource;
uploading, by the computer, an image of the first physical resource to the on-demand virtual queue, the image containing metadata regarding a geographic location of the first physical resource;
receiving, by the computer, a request to utilize the first physical resource from a second user;
adding, by the computer, the second user to the on-demand virtual queue for the first physical resource;
sending, by the computer, an indication that the first physical resource is available with the geographic location of the first physical resource to the second user who is first in the on-demand virtual queue; and
removing, by the computer, the second user from the on-demand virtual queue in response to receiving an indication that the second user finished utilizing the first physical resource.

2. The computer-implemented method of claim 1, further comprising:
determining, by the computer, whether the on-demand virtual queue had already been generated for the first physical resource based on a previous user request to track the availability of the first physical resource; and
generating, by the computer, the on-demand virtual queue for the first physical resource in response to the computer determining that the on-demand virtual queue had not already been generated for the first physical resource.

3. The computer-implemented method of claim 2, further comprising:
adding, by the computer, the first user to the on-demand virtual queue in response to the computer determining that the on-demand virtual queue had already been generated for the first physical resource based on the previous user request to track the availability of the first physical resource; and
identifying, by the computer, a position of the first user in the on-demand virtual queue.

4. The computer-implemented method of claim 1, wherein the on-demand virtual queue corresponds to the first physical resource, and wherein the computer generates the on-demand virtual queue enabling users who want to use the first physical resource to register in the on-demand virtual queue to receive an indication that the first physical resource is available for a particular user to use, allowing the users to avoid long lines, long wait times, and uncertainty for obtaining the first physical resource for usage.

5. The computer-implemented method of claim 1, wherein the computer dynamically alters an order of the first user and the second user in the on-demand virtual queue based on at least one of the geographic location of the first physical resource, a geolocation of the first user and the second user when requesting usage of the first physical resource, and a requested time to utilize the first physical resource by the first user and the second user.

6. The computer-implemented method of claim 1, further comprising:
identifying, by the computer, a second physical resource that is an equivalent physical resource to the first physical resource.

7. The computer-implemented method of claim 6, further comprising:
determining, by the computer, whether the equivalent physical resource is available for usage prior to the first physical resource being available for usage by the first user based on a position of the first user in the on-demand virtual queue;
transferring, by the computer, the first user automatically to a different on-demand virtual queue corresponding to the equivalent physical resource in response to the computer determining that the equivalent physical resource is available for usage prior to the first physical resource being available for usage by the first user based on the position of the first user in the on-demand virtual queue; and
notifying, by the computer, the first user when the equivalent physical resource is available to the first user for usage according to the different on-demand virtual queue.

8. The computer-implemented method of claim 1, wherein the first physical resource is one of a physical tool, physical machine, physical instrument, or physical part of an object that is being one of manufactured or repaired.

9. A computer system for managing high-demand physical resource usage, the computer system comprising:
a communication fabric;
a storage device connected to the communication fabric, wherein the storage device stores program instructions; and
a processor connected to the communication fabric, wherein the processor executes the program instructions to:
receive an identification of a first physical resource to track availability of the first physical resource via an on-demand virtual queue from a first user who wants to utilize the first physical resource;
upload an image of the first physical resource to the on-demand virtual queue, the image containing metadata regarding a geographic location of the first physical resource;
receive a request to utilize the first physical resource from a second user;
add the second user to the on-demand virtual queue for the first physical resource;
send an indication that the first physical resource is available with the geographic location of the first physical resource to the second user who is first in the on-demand virtual queue; and
remove the second user from the on-demand virtual queue in response to receiving an indication that the second user finished utilizing the first physical resource.

10. The computer system of claim 9, wherein the processor further executes the program instructions to:
determine whether the on-demand virtual queue had already been generated for the first physical resource based on a previous user request to track the availability of the first physical resource; and
generate the on-demand virtual queue for the first physical resource in response to determining that the on-demand virtual queue had not already been generated for the first physical resource.

11. The computer system of claim 10, wherein the processor further executes the program instructions to:
add the first user to the on-demand virtual queue in response to determining that the on-demand virtual queue had already been generated for the first physical resource based on the previous user request to track the availability of the first physical resource; and
identify a position of the first user in the on-demand virtual queue.

12. The computer system of claim 9, wherein the on-demand virtual queue corresponds to the first physical resource, and wherein the processor generates the on-demand virtual queue enabling users who want to use the first physical resource to register in the on-demand virtual queue to receive an indication that the first physical resource is available for a particular user to use, allowing the users to avoid long lines, long wait times, and uncertainty for obtaining the first physical resource for usage.

13. The computer system of claim 9, wherein the processor dynamically alters an order of the first user and the second user in the on-demand virtual queue based on at least one of the geographic location of the first physical resource, a geolocation of the first user and the second user when requesting usage of the first physical resource, and a requested time to utilize the first physical resource by the first user and the second user.

14. A computer program product for managing high-demand physical resource usage, the computer program product comprising a computer-readable storage medium having program instructions embodied therewith, the program instructions executable by a computer to cause the computer to perform a method of:
receiving, by the computer, an identification of a first physical resource to track availability of the first physical resource via an on-demand virtual queue from a first user who wants to utilize the first physical resource;
uploading, by the computer, an image of the first physical resource to the on-demand virtual queue, the image containing metadata regarding a geographic location of the first physical resource;
receiving, by the computer, a request to utilize the first physical resource from a second user;
adding, by the computer, the second user to the on-demand virtual queue for the first physical resource;
sending, by the computer, an indication that the first physical resource is available with the geographic location of the first physical resource to the second user who is first in the on-demand virtual queue; and
removing, by the computer, the second user from the on-demand virtual queue in response to receiving an indication that the second user finished utilizing the first physical resource.

15. The computer program product of claim 14, further comprising:
determining, by the computer, whether the on-demand virtual queue had already been generated for the first physical resource based on a previous user request to track the availability of the first physical resource; and
generating, by the computer, the on-demand virtual queue for the first physical resource in response to the computer determining that the on-demand virtual queue had not already been generated for the first physical resource.

16. The computer program product of claim 15, further comprising:
adding, by the computer, the first user to the on-demand virtual queue in response to the computer determining that the on-demand virtual queue had already been generated for the first physical resource based on the previous user request to track the availability of the first physical resource; and
identifying, by the computer, a position of the first user in the on-demand virtual queue.

17. The computer program product of claim 14, wherein the on-demand virtual queue corresponds to the first physical resource, and wherein the computer generates the on-demand virtual queue enabling users who want to use the first physical resource to register in the on-demand virtual queue to receive an indication that the first physical resource is available for a particular user to use, allowing the users to avoid long lines, long wait times, and uncertainty for obtaining the first physical resource for usage.

18. The computer program product of claim 14, wherein the computer dynamically alters an order of the first user and the second user in the on-demand virtual queue based on at least one of the geographic location of the first physical resource, a geolocation of the first user and the second user when requesting usage of the first physical resource, and a requested time to utilize the first physical resource by the first user and the second user.

19. The computer program product of claim 14, further comprising:
identifying, by the computer, a second physical resource that is an equivalent physical resource to the first physical resource.

20. The computer program product of claim 19, further comprising:
determining, by the computer, whether the equivalent physical resource is available for usage prior to the first physical resource being available for usage by the first user based on a position of the first user in the on-demand virtual queue;
transferring, by the computer, the first user automatically to a different on-demand virtual queue corresponding to the equivalent physical resource in response to the computer determining that the equivalent physical resource is available for usage prior to the first physical resource being available for usage by the first user based on the position of the first user in the on-demand virtual queue; and
notifying, by the computer, the first user when the equivalent physical resource is available to the first user for usage according to the different on-demand virtual queue.
